(19) United States
(12) Patent Application Publication
(10) Pub. No.: US 2020/0264745 A1
(43) Pub. Date: Aug. 20, 2020

(54) GRANULAR CHANGE HISTORY VISUALIZATION

(71) Applicant: Microsoft Technology Licensing, LLC, Redmond, WA (US)

(72) Inventors: Seth Fox, Redmond, WA (US); Erez Kikin Gil, Bellevue, WA (US); Daniel P. Costenaro, Redmond, WA (US); Samuel Shen, Redmond, WA (US); Christopher Andrews Jung, Mercer Island, WA (US); Benjamin D. Smith, Redmond, WA (US)

(21) Appl. No.: 16/278,639

(22) Filed: Feb. 18, 2019

(51) Int. Cl. G06F 3/0484; G06F 3/0481; G06F 17/24; G06F 16/93; G06F 9/451; G06F 16/245

(52) U.S. Cl. CPC G06F 3/0484; G06F 3/0481; G06F 16/245; G06F 16/93; G06F 9/451; G06F 17/241

(57) ABSTRACT

A computing device identifies detects changes to a shared document from a plurality of users. The computing device determines change activities and corresponding provenance to the shared document in response to detecting the changes. A context of granular changes is generated based on the change activities and corresponding provenance to the shared document. The computing device generates a graphical user interface based on the context. The graphical user interface provides a visualization of the granular changes.

### BACKGROUND

The subject matter disclosed herein generally relates to a special-purpose machine that generates a graphical user interface to visualize granular change history of shared documents, including computerized variants of such special-purpose machines and improvements to such variants. Specifically, the present disclosure addresses systems and methods for determining a context of the change history and generating a graphical user interface based on the context.

A shared document is a document that can be asynchronously modified by several users having permission to edit the shared document. A user typically has to enable track changes to a document to view changes from other users. The track change feature displays all changes from all shared users for the shared document. Therefore, it is difficult for a user to distinguish substantive changes (e.g., rewriting an entire paragraph) from non-substantive changes (e.g., typo corrections) to the shared document.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 is a block diagram illustrating an example of an operation of the multiple source media management application in accordance with one example embodiment.

FIG. 3 is a block diagram illustrating a granular change client application in accordance with one example embodiment.

FIG. 4 is a block diagram illustrating a granular change module in accordance with one example embodiment.

FIG. 5 is a block diagram illustrating a contextual module in accordance with one example embodiment.

FIG. 6 illustrates a granular change server application in accordance with one embodiment.

FIG. 7 is a flow diagram illustrating a method for generating a graphical user interface for visualizing granular changes to a shared document in accordance with one example embodiment.

FIG. 8 is a flow diagram illustrating a method for generating a graphical user interface for visualizing granular changes to a shared document based on semantic queries in accordance with one example embodiment.

FIG. 9 is a flow diagram illustrating a method for generating a graphical user interface for visualizing granular changes to a shared document based on quality of changes in accordance with one example embodiment.

FIG. 10 is a flow diagram illustrating a method for generating a graphical user interface for visualizing granular changes to a portion of a shared document in accordance with one example embodiment.

FIG. 11 is a flow diagram illustrating a method for protecting a portion of a shared document from further changes in accordance with one example embodiment.

FIG. 12 is a flow diagram illustrating a method for generating a graphical user interface for visualizing aggregated granular changes to a shared document in accordance with one example embodiment.

FIG. 13 is a flow diagram illustrating a method for generating a graphical user interface for visualizing granular changes to a shared document based on user privilege level in accordance with one example embodiment.

FIG. 14 is a flow diagram illustrating a method for generating a graphical user interface for visualizing granular changes to a shared document based on shared document privacy settings in accordance with one example embodiment.

FIG. 15 is a flow diagram illustrating a method for generating a graphical user interface for visualizing granular changes to a portion of a shared document in accordance with one example embodiment.

FIG. 16 is a flow diagram illustrating a method for generating a graphical user interface for visualizing highlights of changes to a shared document in accordance with one example embodiment.

FIG. 17 is a flow diagram illustrating a method for generating a graphical user interface for visualizing granular changes to a selected portion of a shared document in accordance with one example embodiment.

FIG. 18 illustrates a screenshot of an example graphical user interface in accordance with one example embodiment.

FIG. 19 illustrates a screenshot of an example graphical user interface in accordance with one example embodiment.

FIG. 20 illustrates a screenshot of an example graphical user interface in accordance with one example embodiment.

FIG. 21 illustrates a screenshot of an example graphical user interface in accordance with one example embodiment.

FIG. 22 illustrates a screenshot of an example graphical user interface in accordance with one e example embodiment.

FIG. 23 illustrates a screenshot of an example graphical user interface in accordance with one example embodiment.

FIG. 24 illustrates a screenshot of an example graphical user interface in accordance with one example embodiment.

FIG. 25 illustrates a screenshot of an example graphical user interface in accordance with one example embodiment.

FIG. 26 illustrates a screenshot of an example graphical user interface in accordance with one example embodiment.

FIG. 27 illustrates a screenshot of an example graphical user interface in accordance with one example embodiment.

FIG. 28 illustrates a screenshot of an example graphical user interface in accordance with one example embodiment.

FIG. 29 is a diagrammatic representation of a machine in the form of a computer system within which a set of instructions may be executed for causing the machine to perform any one or more of the methodologies discussed herein, according to an example embodiment.

### DETAILED DESCRIPTION

“Processor” refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Signal Medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“Machine-Storage Medium” refers to a single or multiple storage devices and/or media (e.g., a centralized or distributed database, and/or associated caches and servers) that store executable instructions, routines and/or data. The term shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Computer-Readable Medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Carrier Signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Communication Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Users sharing a document (e.g., a Word document or any other types of document) can asynchronously modify the shared document. However, these changes are not displayed by default to a user that receives the updated document. The user is required to enable or turn on a track change feature that enables the updated document to display the changes. Furthermore, those changes reflect all types of changes made to the shared document regardless of whether each change is a substantive change (e.g., rewriting an entire paragraph) or a non-substantive change (e.g., typo correction). The track change feature operates as an all or nothing feature. In the “off” setting, the shared document does not display any changes. In the on setting, the shared document displays all changes (relevant and irrelevant to the user). As such, in the on setting of the track change feature, a user has to sort through all the noise (e.g., all change information) to distinguish changes that are pertinent and relevant to the user.

In one example embodiment, a user identifies a portion of the shared document. The graphical user interface display information relevant to the portion of the shared document. For example, the information can include which users edited the portion, what was edited for each user, a link to the original content in the portion, a view of change over time, and related documents. In another example embodiment, the graphical user interface displays a highlight of the changes in the shared document. In another example embodiment, the graphical user interface enables a user to drill in on a portion of the shared document to further view more detailed history about the content in the portion of the shared document.

The present application describes a system and method for generating a graphical user interface that displays granular changes to a shared document. In one example embodiment, a computing device identifies detects changes to a shared document from a plurality of users. The computing device determines change activities and corresponding provenance to the shared document in response to detecting the changes. A context of granular changes is generated based on the change activities and corresponding provenance to the shared document. The computing device generates a graphical user interface based on the context. The graphical user interface provides a visualization of the granular changes.

As a result, one or more of the methodologies described herein facilitate solving the technical problem of identifying and controlling which media applications that are operating in a computing device. As such, one or more of the methodologies described herein may obviate a need for certain efforts or computing resources that otherwise would be involved in opening web browser, or searching for other applications that may be responsible for playing a media file at the computing device, resources used by one or more machines, databases, or devices (e.g., within the environment) may be reduced the relevancy of the messages is based on the file activities. Examples of such computing resources include processor cycles, network traffic, memory usage, data storage capacity, power consumption, network bandwidth, and cooling capacity.

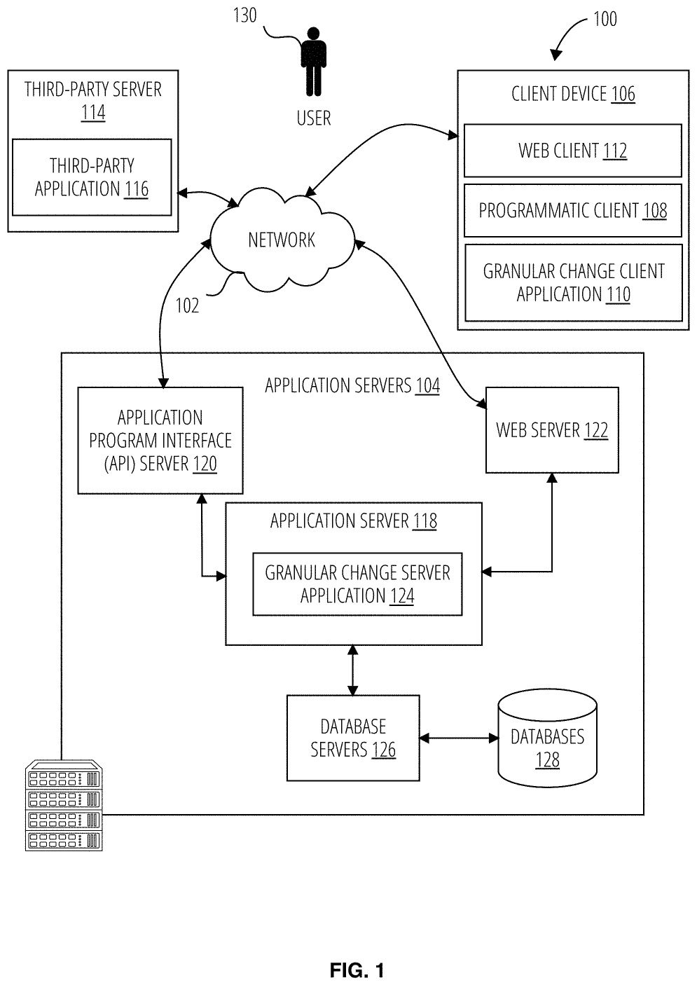

FIG. 1 is a diagrammatic representation of a network environment in which some example embodiments of the present disclosure may be implemented or deployed. One or more application servers 104 provide server-side functionality via a network 102 to a networked user device, in the form of a client device 106. The client device 106 includes a web client 112 (e.g., a browser), a programmatic client 108 (e.g., Microsoft Word™ “app”) that is hosted and executed on the client device 106, and a granular change client application 110 that generates a graphical user interface to visualize changes to shared document. The granular change client application 110 may operate with the web client 112 and/or the programmatic client 108. In another example embodiment, the granular change client application 110 is part of the programmatic client 108 or web client 112.

An Application Program Interface (API) server 120 and a web server 122 provide respective programmatic and web interfaces to application servers 104. A specific application server 118 hosts a granular change server application 124, which includes components, modules and/or applications. The granular change server application 124 receives and detects changes to a shared document from other client devices. The granular change server application 124 generates a graphical user interface based on the changes. In one example embodiment, the granular change client application 110 communicates with the granular change server application 124 supported by the web server 122 to access the graphical user interface. In one example, the web client 112 communicate with the granular change server application 124 via the programmatic interface provided by the Application Program Interface (API) server 120. In another example, the granular change client application 110 communicates with the granular change server application 124.

The third-party application 116 may, for example, be another cloud storage system or another media provider. The application server 118 is shown to be communicatively coupled to database servers 126 that facilitates access to an information storage repository or databases 128. In an example embodiment, the databases 128 includes storage devices that store information to be published and/or processed by the granular change server application 124.

Additionally, a third-party application 116 executing on a third-party server 114, is shown as having programmatic access to the application server 118 via the programmatic interface provided by the Application Program Interface (API) server 120. For example, the third-party application 116, using information retrieved from the application server 118, may supports one or more features or functions on a website hosted by the third party.

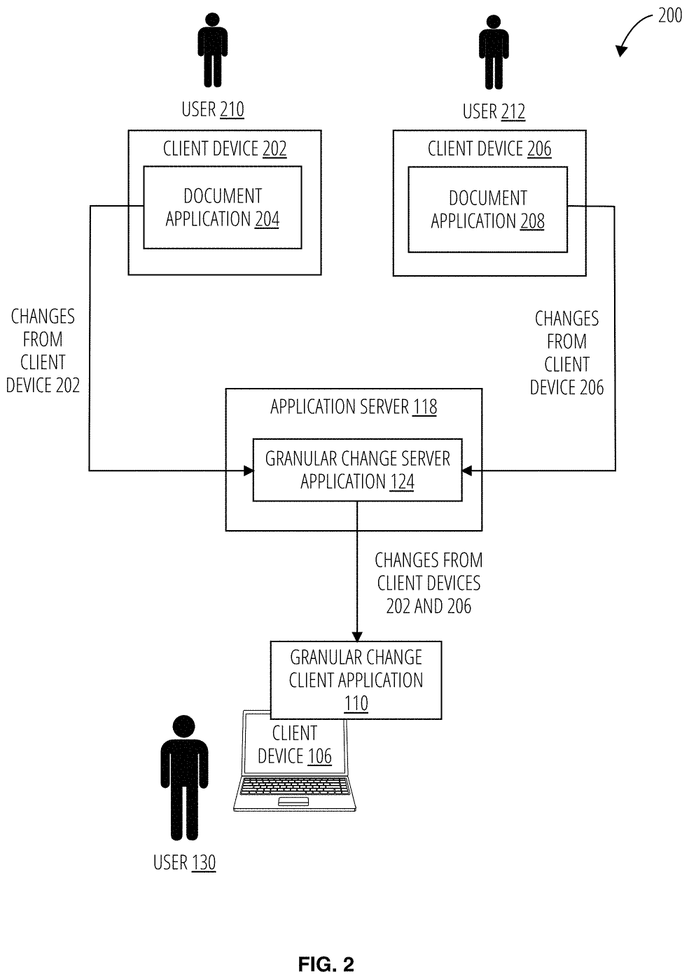

FIG. 2 is a block diagram illustrating an example of an operation of the multiple source media management application in accordance with one example embodiment. A user 210 operates a document application 204 (e.g., Microsoft Word™) at a client device 202 to edit changes to a shared document. The client device 202 sends the updated document (e.g., shared document with changes) to the granular change server application 124. Similarly, a user 212 operates a document application 208 (e.g., Microsoft Word™) at a client device 206 to edit changes to the same shared document. The client device 206 sends the updated document (e.g., shared document with changes) to the granular change server application 124. The application server 118 asynchronously receives the updated documents. In one example, the application server 118 generates an updated document based on the changes from client device 202 and client device 206. The granular change server application 124 sends the updated document to the granular change client application 110.

The user 130 operates the client device 106 to view or edit a shared document via a graphical user interface provided by the granular change client application 110. The granular change client application 110 enables the user to display changes performed to the shared document on a more granular level (instead of displaying all changes). For example, the granular change client application 110 summarizes or highlights changes to the shared document. In another example, the granular change client application 110 displays changes that are relevant to the user based on a context of the user (e.g., user credentials) or privacy settings of the other users having access to the shared document (e.g., user 210, user 212). In another example, the granular change client application 110 determines aggregates the change performed by the user 210 and user 212, determines the type of changes (e.g., grammar change, typographical change, sentence replacement), and generates a visualization of the types of changes on the shared document. As such, the user 130 can easily identify which other user (and to what extent) has performed substantive revisions or superficial revisions.

In one example embodiment, the granular change client application 110 generates a graphical user interface to visualize the granular changes on the client device 106. In another example embodiment, the granular change server application 124 generates a graphical user interface to visualize the granular changes and provides the graphical user interface to the granular change client application 110.

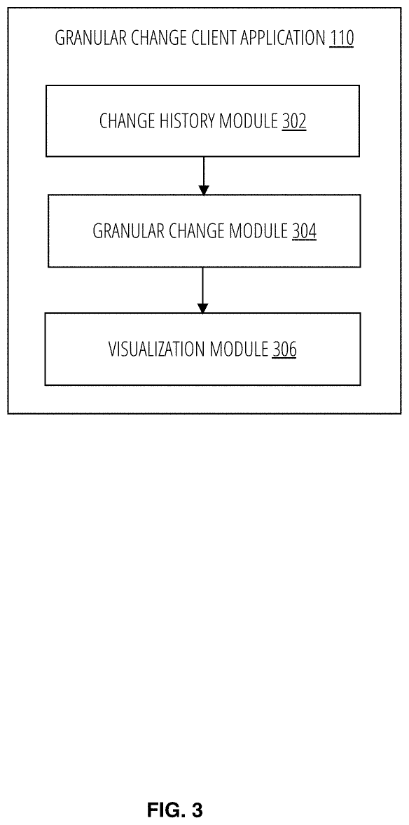

FIG. 3 is a block diagram illustrating a granular change client application 110 in accordance with one example embodiment. The granular change client application 110 comprises a change history module 302, a granular change module 304, and a visualization module 306. The change history module 302 detects changes (made by other users) to the shared document. The change history module 302 logs a history of the changes (e.g., which user changed the shared document, what was the content that was changed, when was the content changed). In one example, the change history module 302 accesses metadata from the shared document received from each user to identify the respective changes.

The granular change module 304 identifies the types of changes performed to the shared document. In another example, the granular change module 304 generates a highlight or summary of the changes to the shared document. In another example, the granular change module 304 determines changes that are relevant to the user based on a context of the user (e.g., user credentials, user profile, user interest, related documents) or privacy settings of the user 130 (or other users having access to the shared document (e.g., user 210, user 212)). In another example, the granular change module 304 aggregates the change activities (from all users having revision access to the shared document), determines the type of changes (e.g., grammar change, typographical change, sentence replacement). In another example, the granular change module 304 receives a selection of a portion of the shared document and generates a summary of change activities performed on (or pertaining to) the selected portion of the shared document. Only the summary of change activities is displayed with respect to the portion of the shared document. In other words, no change activity is displayed with respect to the other portions (or remainder) of the shared document.

The visualization module 306 generates a graphical user interface to generate a granular visualization of the changes (e.g., who changed, how substantive, types of changes, history of changes, identification of related documents or other parts of the shared document, or links to other related documents) on the shared document. Thus, the visualization module 306 enables the user 130 to easily identify which other user (and to what extent) has performed substantive revisions or superficial revisions. The user 130 can drill down on the graphical user interface to view more detailed history of the changes.

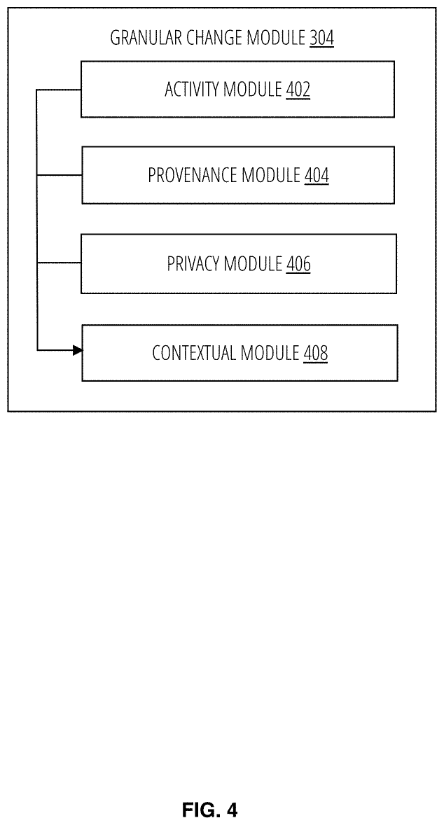

FIG. 4 is a block diagram illustrating the granular change module 304 of FIG. 3 in accordance with one example embodiment. The granular change module 304 comprises an activity module 402, a provenance module 404, a privacy module 406, and a contextual module 408.

The activity module 402 determines a type of changes (e.g., substantive, non-substantive). For example, the activity module 402 determines that changes to correct spelling and grammar are non-substantive, and changes to reword or add new sentences is substantive. For example, the activity module 402 quantifies the type of changes (e.g., the shared document has a total of 10 changes (since the first version, or since version n of one week ago): 20% of the changes are considered substantive (50% of the substantive changes are from user 130 and 50% of the substantive changes are from user 210), 80% of the changes are considered non-substantive (100% of the non-substantive are from user 212).

In another example, the activity module 402 determines changes (to the shared document) based on a number of changes and time of the corresponding changes. For example, within the last 24 hours, 30% of document has changed: 80% of the changes were performed by user 210, 20% of the changes were performed by user 212. Those of ordinary skill in the art will recognize that other types of activities besides types of changes, time of changes can be used, for example, time of change, amount of change, profile of users performing the change, etc.

The provenance module 404 determines a source of the change. For example, changes to a portion of the shared document can be modified from versions to versions. A provenance metadata is associated with portion (e.g., paragraph or any other user defined part) of the shared document to log the changes to the relevant portion and creates a chain of event or history of the changes (e.g., user 130 wrote the original portion on Monday, user 210 added a comma to the portion on Tuesday, user 212 removed a word and added a sentence to the portion on Wednesday).

The privacy module 406 determines a privacy setting or privilege for the shared document and the shared users. For example, the shared document may contain some sensitive parts (e.g., quarterly financial results). The privacy module 406 determines that user 212 does not have the required privilege to view changes pertaining to the sensitive part. Therefore, a summary/aggregate (non-detailed) of the changes may be generated for the user 212 (e.g., when user clicks on the sensitive part, he/she will see “minor changes performed by accounting team)). On the other hand, a user with the required privilege can view the changes pertaining to the sensitive part in more detail: for example, “user 130 changed 1% growth to 3% growth yesterday.”

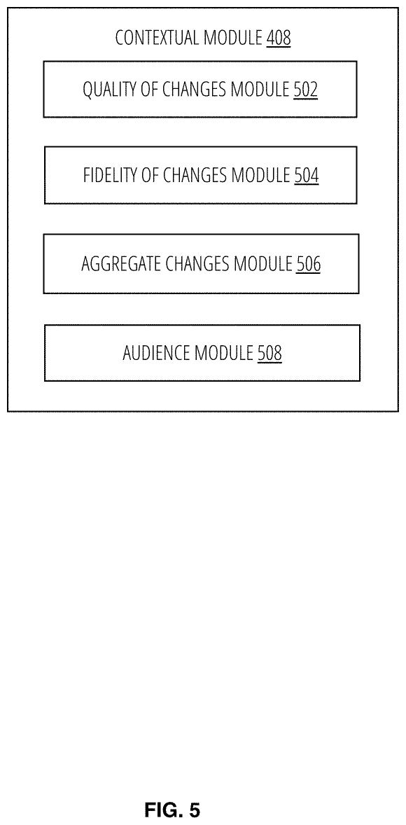

The contextual module 408 forms a context based on the change activities determined by the activity module 402, the origin of the content (or historical log of changes) determined by provenance module 404, and the privacy setting determined by the privacy module 406. The contextual module 408 determines the level of information to be displayed in the graphical user interface based on the context. The contextual module 408 is described in more detail below with respect to FIG. 5.

FIG. 5 is a block diagram illustrating a contextual module in accordance with one example embodiment. The contextual module 408 comprises a quality of changes module 502, a fidelity of changes module 504, an aggregate changes module 506, and an audience module 508.

The quality of changes module 502 determines a quality of changes based on the types of changes determined by the activity module 402. For example, the quality of changes module 502 determines that the shared document has a total of 10 changes (since the first version, or since version n of one week ago): 20% of the changes are considered substantive (50% of the substantive changes are from user 130 and 50% of the substantive changes are from user 210), 80% of the changes are considered non-substantive (100% of the non-substantive are from user 212).

The fidelity of changes module 504 determines a fidelity of changes performed to the shared document. For example, the fidelity of changes module 504 is able to determine the type of changes, who performed the changes, when the changes were performed, a quality of the changes based on a semantic query.

The aggregate changes module 506 aggregates the changes or summarize the changes to the relevant or corresponding portions of the shared document. For example, the first paragraph was originally written by user 130 on day 1, substantively modified two times on day 2 by user 210 with two new sentences added and a revision to one original sentence, and non-substantively modified ten times on day 10 by user 212 with changes comprising synonyms, format correction, punctuation.

The audience module 508 determines the reading privileges or security rights of the users of the shared document. For example, user 130 is an executive with access to financial data in the shared document. User 210 is a manager with no access to financial data in the document. In another example, user 210 can ask permission from user 130 to view the financial data (or changes to the financial data) in the shared document.

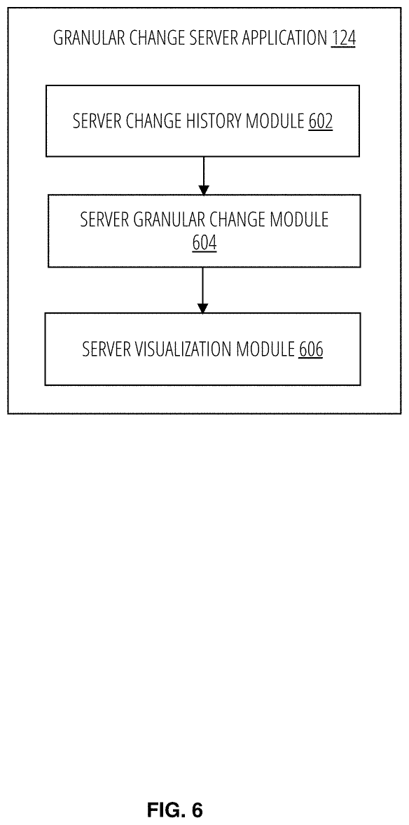

FIG. 6 illustrates a granular change server application in accordance with one embodiment. The granular change server application 124 comprises a server change history module 602, a server granular change module 604, and a server visualization module 606. The server change history module 602 operates similarly to the change history module 302 of the granular change client application 110. The server granular change module 604 operates similarly to the granular change module 304 of the granular change client application 110. The server visualization module 606 operates similarly to the visualization module 306 of the granular change client application 110.

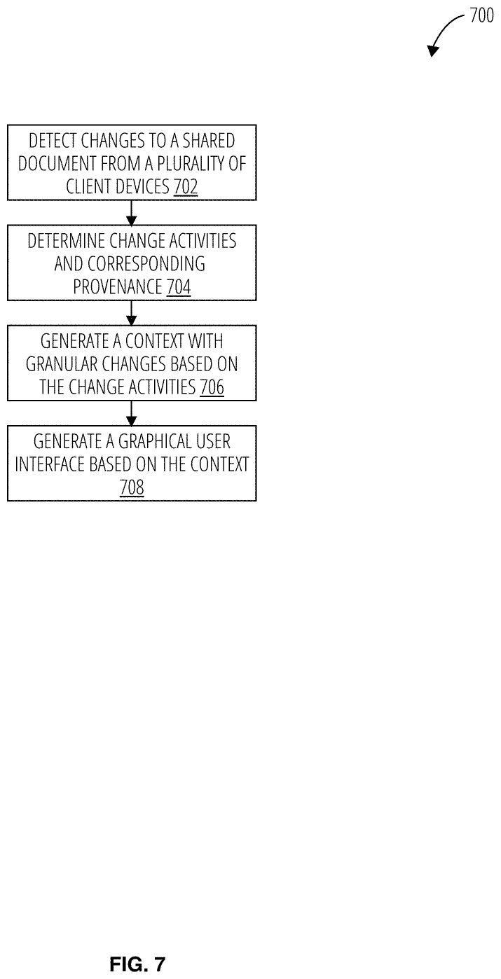

FIG. 7 is a flow diagram illustrating a method 700 for generating a graphical user interface for visualizing granular changes to a shared document in accordance with one example embodiment. Operations in the method 700 may be performed by the granular change client application 110, using components (e.g., modules, engines) described above with respect to FIG. 3. Accordingly, the method 700 is described by way of example with reference to the granular change client application 110. However, it shall be appreciated that at least some of the operations of the method 700 may be deployed on various other hardware configurations or be performed by similar components residing elsewhere. For example, some of the operations may be performed at the granular change server application 124.

In block 702, the granular change client application 110 detects changes to a shared document from a plurality of devices (or users having rights to modify the shared document). At block 704, the granular change client application 110 determines change activities and corresponding provenance to the shared document (e.g., who changed what, when, and how). At block 706, the granular change client application 110 generates a context with granular changes based on the change activities. At block 708, the granular change client application 110 generates a graphical user interface based on the context.

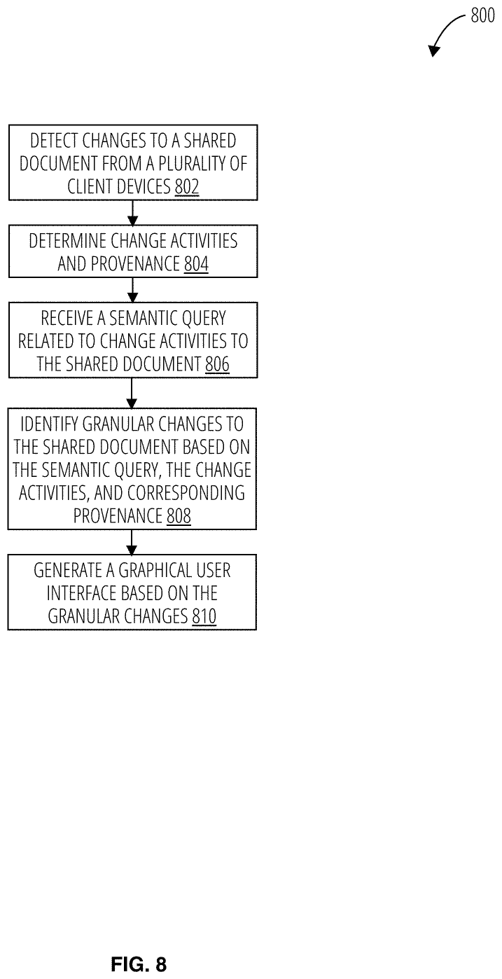

FIG. 8 is a flow diagram illustrating a method 800 for generating a graphical user interface for visualizing granular changes to a shared document based on semantic queries in accordance with one example embodiment. Operations in the method 800 may be performed by the granular change client application 110, using components (e.g., modules, engines) described above with respect to FIG. 3. Accordingly, the method 800 is described by way of example with reference to the granular change client application 110. However, it shall be appreciated that at least some of the operations of the method 800 may be deployed on various other hardware configurations or be performed by similar components residing elsewhere. For example, some of the operations may be performed at the granular change server application 124.

At block 802, the granular change client application 110 detects changes to a shared document from a plurality of client devices (or users having rights to modify the shared document). At block 804, the granular change client application 110 determines change activities and corresponding provenance to the shared document (e.g., who changed what, when, and how). At block 806, the granular change client application 110 receives a semantic query related to changes activities to the shared document. For example, the semantic query includes a request to view only substantive changes performed only by user 212 from two weeks ago. At block 808, the granular change client application 110 identifies granular changes to the shared document based on the semantic query, the change activities, and the corresponding provenance. At block 810, the granular change client application 110 generates a graphical user interface based on the granular changes.

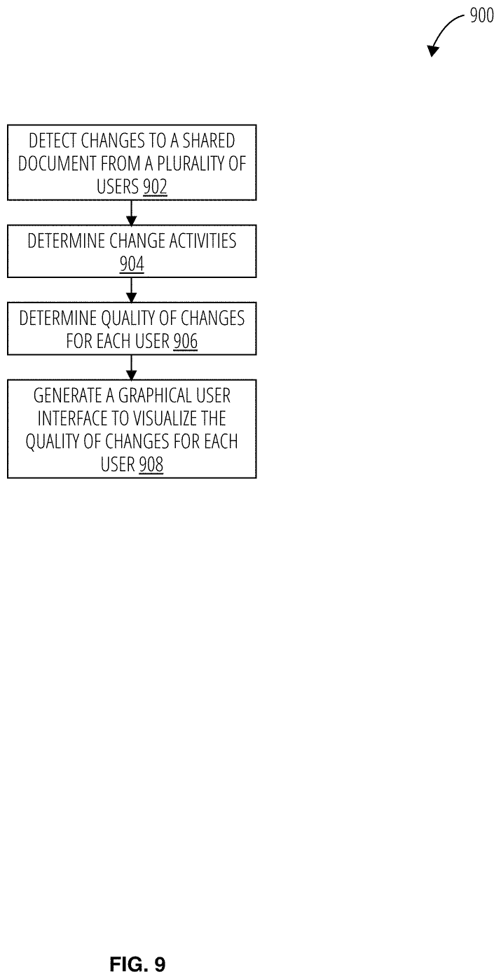

FIG. 9 is a flow diagram a method 900 for generating a graphical user interface for visualizing granular changes to a shared document based on quality of changes in accordance with one example embodiment. Operations in the method 900 may be performed by the granular change client application 110, using components (e.g., modules, engines) described above with respect to FIG. 3. Accordingly, the method 900 is described by way of example with reference to the granular change client application 110. However, it shall be appreciated that at least some of the operations of the method 900 may be deployed on various other hardware configurations or be performed by similar components residing elsewhere. For example, some of the operations may be performed at the granular change server application 124.

In block 902, the granular change client application 110 detects changes to a shared document from a plurality of users having rights to modify the shared document. At block 904, the granular change client application 110 determines change activities to the shared document (e.g., who changed what, when, and how). At block 906, the granular change client application 110 determines a quality of the changes for each user based on the change activities. At block 908, the granular change client application 110 generates a graphical user interface to visualize the quality of changes for each user.

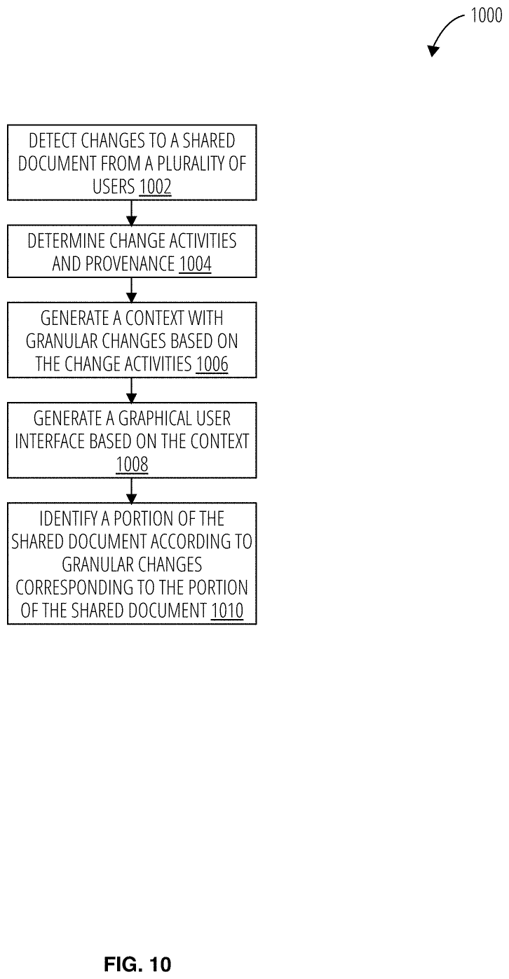

FIG. 10 is a flow diagram illustrating a method 1000 for generating a graphical user interface for visualizing granular changes to a portion of a shared document in accordance with one example embodiment. Operations in the method 1000 may be performed by the granular change client application 110, using components (e.g., modules, engines) described above with respect to FIG. 3. Accordingly, the method 1000 is described by way of example with reference to the granular change client application 110. However, it shall be appreciated that at least some of the operations of the method 1000 may be deployed on various other hardware configurations or be performed by similar components residing elsewhere. For example, some of the operations may be performed at the granular change server application 124.

In block 1002, the granular change client application 110 detects changes to a shared document from a plurality of users having rights to modify the shared document. At block 1004, the granular change client application 110 determines change activities and corresponding provenance to the shared document (e.g., who changed what, when, and how). At block 1006, the granular change client application 110 generates a context with granular changes based on the change activities. At block 1008, the granular change client application 110 generates a graphical user interface based on the context. At block 1010, the granular change client application 110 identifies a portion of the shared document according to the granular changes corresponding to the portion of the shared document.

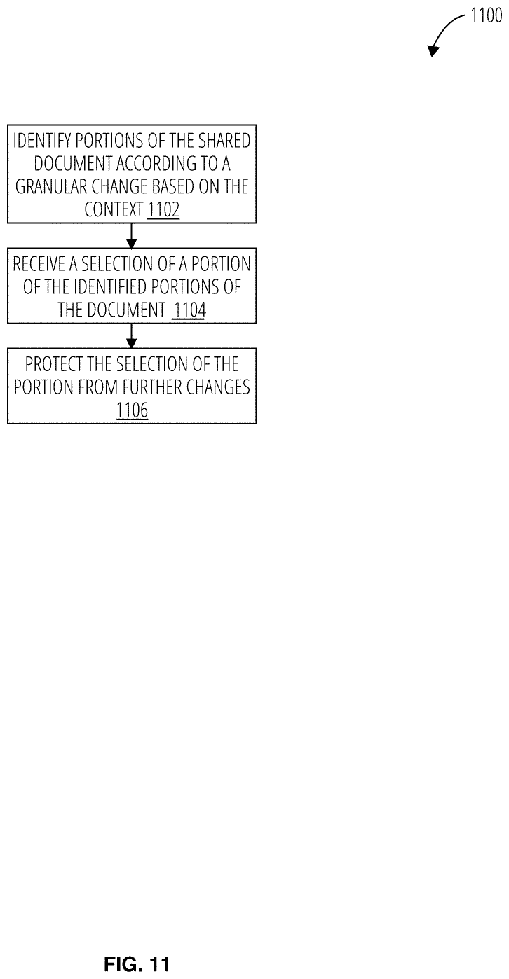

FIG. 11 is a flow diagram illustrating a method 1100 for protecting a portion of a shared document from further changes in accordance with one example embodiment. Operations in the method 1100 may be performed by the granular change client application 110, using components (e.g., modules, engines) described above with respect to FIG. 3. Accordingly, the method 1100 is described by way of example with reference to the granular change client application 110. However, it shall be appreciated that at least some of the operations of the method 1100 may be deployed on various other hardware configurations or be performed by similar components residing elsewhere. For example, some of the operations may be performed at the granular change server application 124.

In block 1102, the granular change client application 110 identifies portions of the shared document according to a granular change based on the context. At block 1104, the granular change client application 110 receives a selection of the identified portions. At block 1106, the granular change client application 110 protects the selection of identified portions from further changes by other users. In one example, the granular change client application 110 creates a metadata that indicates that the selected identified portion is locked and cannot be further changed.

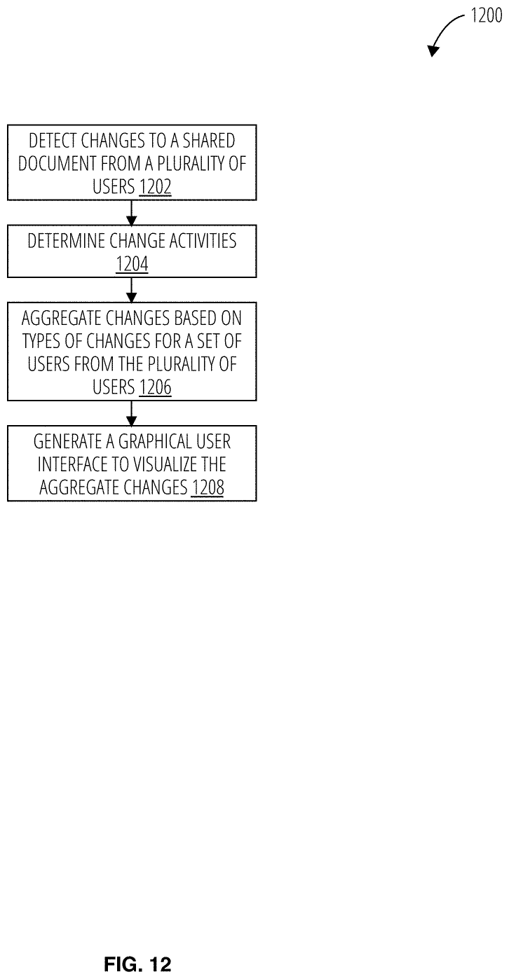

FIG. 12 is a flow diagram illustrating a method 1200 for generating a graphical user interface for visualizing aggregated granular changes to a shared document in accordance with one example embodiment. Operations in the method 1200 may be performed by the granular change client application 110, using components (e.g., modules, engines) described above with respect to FIG. 3. Accordingly, the method 1200 is described by way of example with reference to the granular change client application 110. However, it shall be appreciated that at least some of the operations of the method 1200 may be deployed on various other hardware configurations or be performed by similar components residing elsewhere. For example, some of the operations may be performed at the granular change server application 124.

In block 1202, the granular change client application 110 detects changes to a shared document from a plurality of users having rights to modify the shared document. At block 1204, the granular change client application 110 determines change activities and corresponding provenance to the shared document (e.g., who changed what, when, and how). At block 1206, the granular change client application 110 aggregates the changes based on the types of changes for a set of users (e.g., users from marketing department) from the plurality of users (e.g., entire company branch). At block 1208, the granular change client application 110 generates a graphical user interface to visualize the aggregated changes.

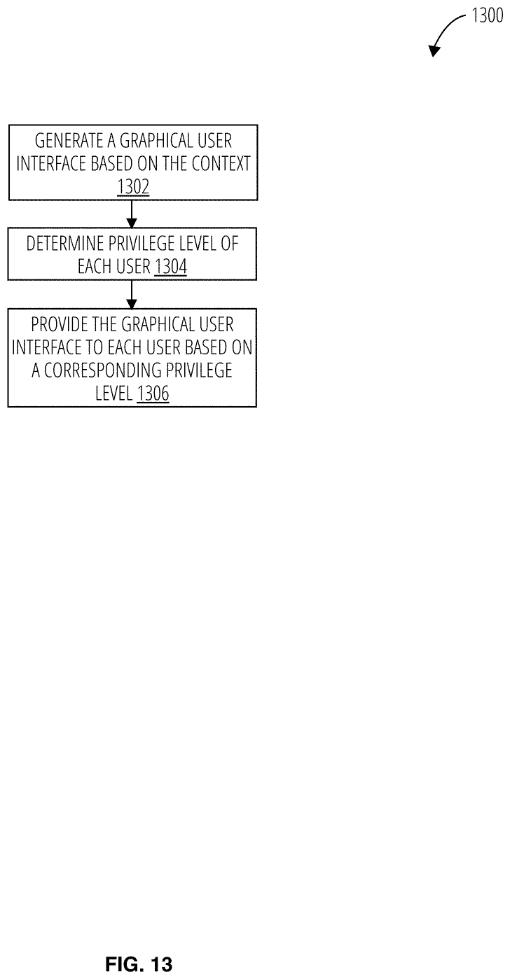

FIG. 13 is a flow diagram illustrating a method for generating a graphical user interface for visualizing granular changes to a shared document based on user privilege level in accordance with one example embodiment. Operations in the method 1300 may be performed by the granular change client application 110, using components (e.g., modules, engines) described above with respect to FIG. 3. Accordingly, the method 1300 is described by way of example with reference to the granular change client application 110. However, it shall be appreciated that at least some of the operations of the method 1300 may be deployed on various other hardware configurations or be performed by similar components residing elsewhere. For example, some of the operations may be performed at the granular change server application 124.

At block 1302, the granular change client application 110 generates a graphical user interface based on the context. At block 1304, the granular change client application 110 determines a privilege level of each user. At block 1306, the granular change client application 110 provides the graphical user interface to each user based on a corresponding privilege level. For example, some users may be able to view details on some changes while other users may not (depending on their privilege rights/level).

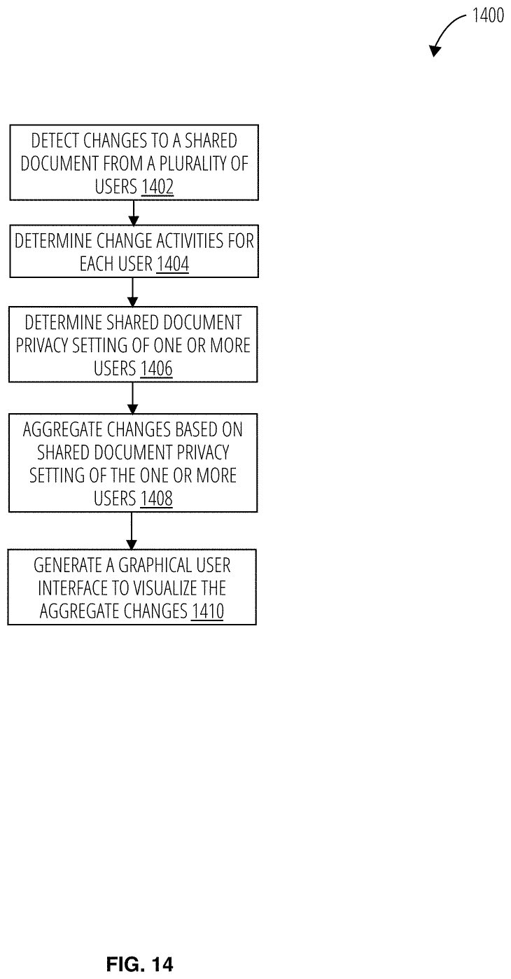

FIG. 14 is a flow diagram illustrating a method for generating a graphical user interface for visualizing granular changes to a shared document based on shared document privacy settings in accordance with one example embodiment. Operations in the method 1400 may be performed by the granular change client application 110, using components (e.g., modules, engines) described above with respect to FIG. 3. Accordingly, the method 1400 is described by way of example with reference to the granular change client application 110. However, it shall be appreciated that at least some of the operations of the method 1400 may be deployed on various other hardware configurations or be performed by similar components residing elsewhere. For example, some of the operations may be performed at the granular change server application 124.

At block 1402, the granular change client application 110 detects changes to a shared document from a plurality of users. At block 1404, the granular change client application 110 determines change activities for each user. At block 1406, the granular change client application 110 determines shared document privacy setting of one or more users. At 1408, the granular change client application 110 aggregate changes based on the shared document privacy setting of one or more users. At 1410, the granular change client application 110 generates a graphical user interface to visualize the aggregate changes.

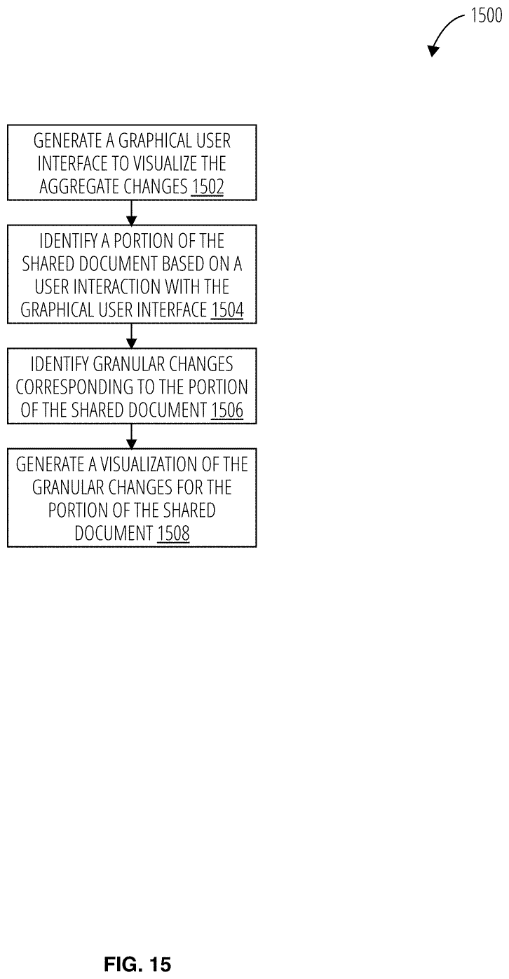

FIG. 15 is a flow diagram illustrating a method for generating a graphical user interface for visualizing granular changes to a portion of a shared document in accordance with one example embodiment. Operations in the method 1500 may be performed by the granular change client application 110, using components (e.g., modules, engines) described above with respect to FIG. 3. Accordingly, the method 1500 is described by way of example with reference to the granular change client application 110. However, it shall be appreciated that at least some of the operations of the method 1500 may be deployed on various other hardware configurations or be performed by similar components residing elsewhere. For example, some of the operations may be performed at the granular change server application 124.

At block 1502, the granular change client application 110 generates a graphical user interface to visualize aggregate changes. At block 1504, the granular change client application 110 identifies a portion of the shared document based on a user interaction with the graphical user interface. At block 1506, the granular change client application 110 generates a visualization of the granular changes for the portion of the shared document.

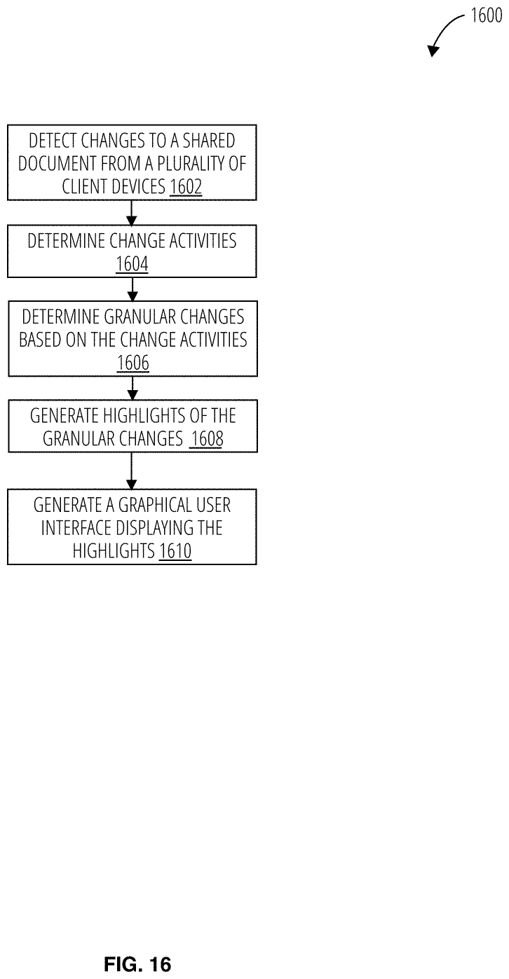

FIG. 16 is a flow diagram illustrating a method for generating a graphical user interface for visualizing highlights of changes to a shared document in accordance with one example embodiment. Operations in the method 1600 may be performed by the granular change client application 110, using components (e.g., modules, engines) described above with respect to FIG. 3. Accordingly, the method 1600 is described by way of example with reference to the granular change client application 110. However, it shall be appreciated that at least some of the operations of the method 1600 may be deployed on various other hardware configurations or be performed by similar components residing elsewhere. For example, some of the operations may be performed at the granular change server application 124.

At block 1602, the granular change client application 110 detects changes to a shared document from a plurality of client devices. At block 1604, the granular change client application 110 determines change activities. At block 1606, the granular change client application 110 determines granular changes based on the change activities. At block 1608, the granular change client application 110 generates highlights of the granular changes. At block 1610, the granular change client application 110 generates a graphical user interface displaying the highlights.

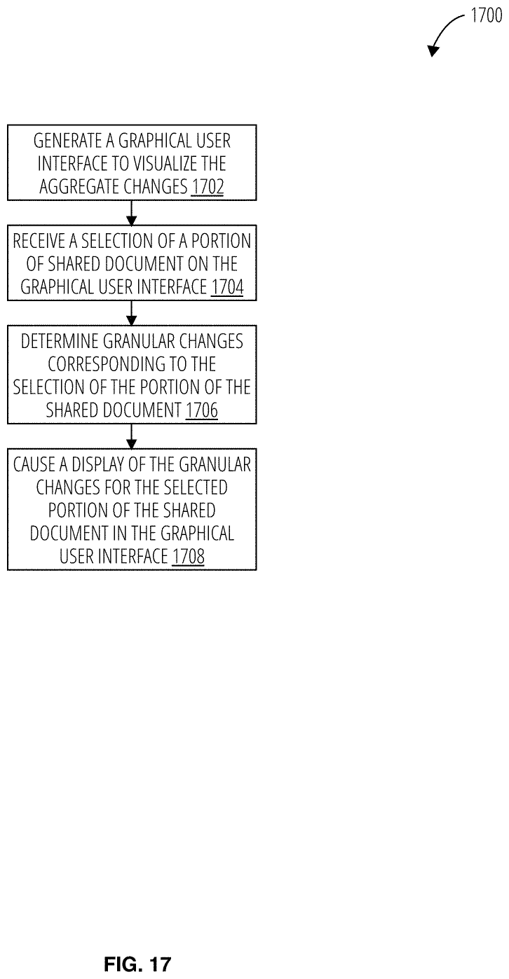

FIG. 17 is a flow diagram illustrating a method for generating a graphical user interface for visualizing granular changes to a selected portion of a shared document in accordance with one example embodiment. Operations in the method 1700 may be performed by the granular change client application 110, using components (e.g., modules, engines) described above with respect to FIG. 3. Accordingly, the method 1700 is described by way of example with reference to the granular change client application 110. However, it shall be appreciated that at least some of the operations of the method 1700 may be deployed on various other hardware configurations or be performed by similar components residing elsewhere. For example, some of the operations may be performed at the granular change server application 124.

At block 1702, the granular change client application 110 generates a graphical user interface to visualize aggregate changes. At block 1704, the granular change client application 110 receives a selection of a portion of a shared document on the graphical user interface. At block 1706, the granular change client application 110 determines granular changes corresponding to the selection of the portion of the shared document. At block 1708, the granular change client application 110 causes a display of the granular changes for the selected portion of the shared document in the graphical user interface.

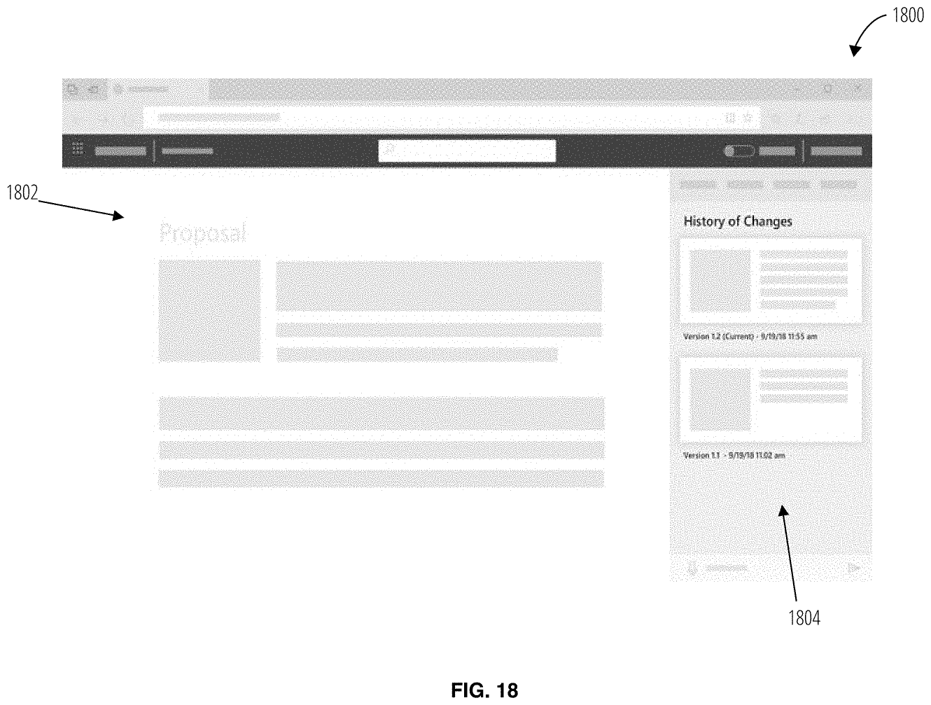

FIG. 18 illustrates a screenshot 1800 in accordance with one embodiment. The screenshot 1800 illustrates a shared document 1802 along with granular history 1804. In another example embodiment, the present application describes a method to respect a user's privacy setting (with respect the user's revision history) from the granular history 1804 given an infinitely granular history. The user's privacy setting can prevent other users from viewing a subset of edits (types of edits, time, etc.). In another example, the user's privacy setting may enable the user with a method to delete history. In another example, the granular change client application 110 uses machine learning to aggregate changes, and let users set their preference for what level/type of changes can be seen by others.

In another example, the present application describes a superior tracked changes and auditing support that does not require being enabled by users in advance. In other words, a user does not need to manually turn on “track changes” features prior to editing a document.

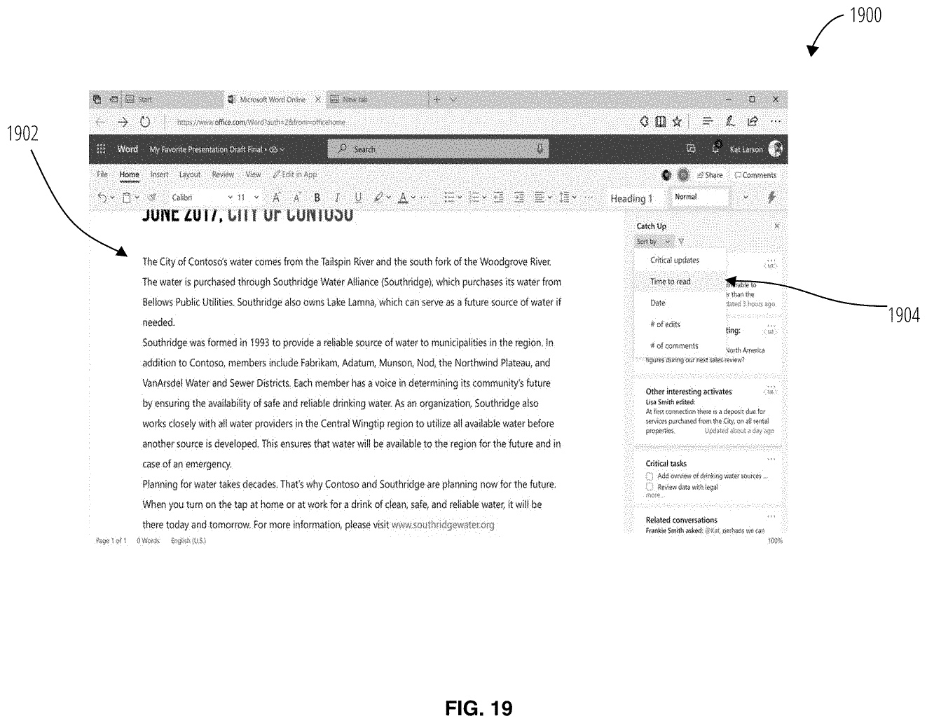

FIG. 19 illustrates a screenshot 1900 in accordance with one embodiment. The screenshot 1900 illustrates a shared document 1902. Pertinent changes to the shared document 1902 can be shown based on a granular category 1904 (e.g., critical updates, time to read, date, number of edits, and number of comments). The screenshot 1900 illustrates a user selecting a time to read category in the granular category 1904.

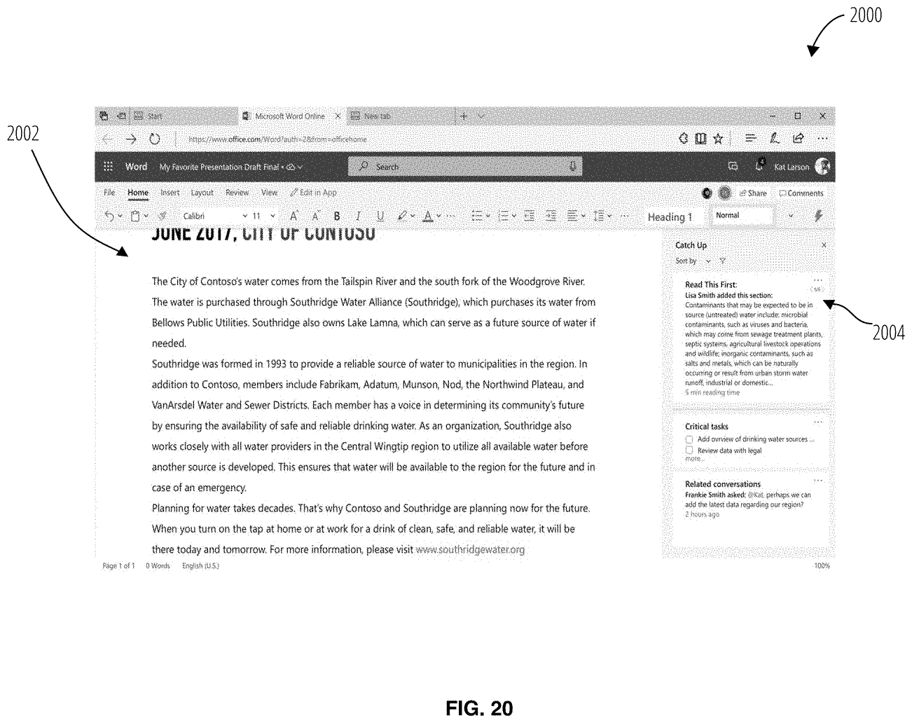

FIG. 20 illustrates a screenshot 2000 in accordance with one embodiment. The screenshot 2000 illustrates a shared document 2002. A summary of important changes to the shared document 2002 is displayed in an annotated box 2004.

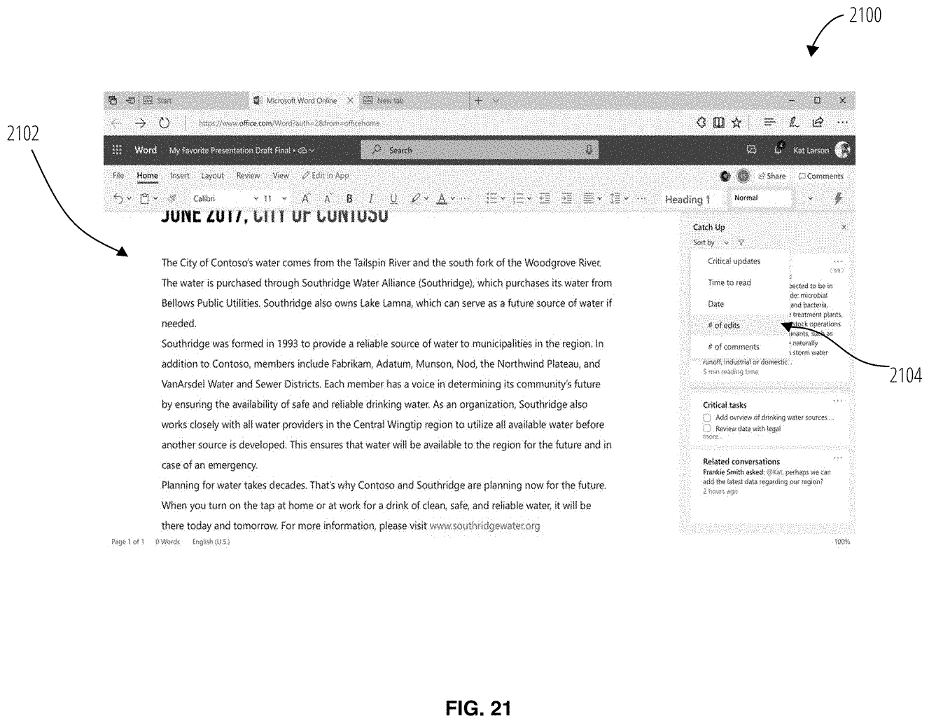

FIG. 21 illustrates a screenshot 2100 in accordance with one embodiment. The screenshot 2100 illustrates a shared document 2102. Pertinent changes to the shared document 2102 can be shown based on a granular category 2104 (e.g., critical updates, time to read, date, number of edits, and number of comments). The screenshot 2100 illustrates a user selecting a number of edits in the granular category 2104.

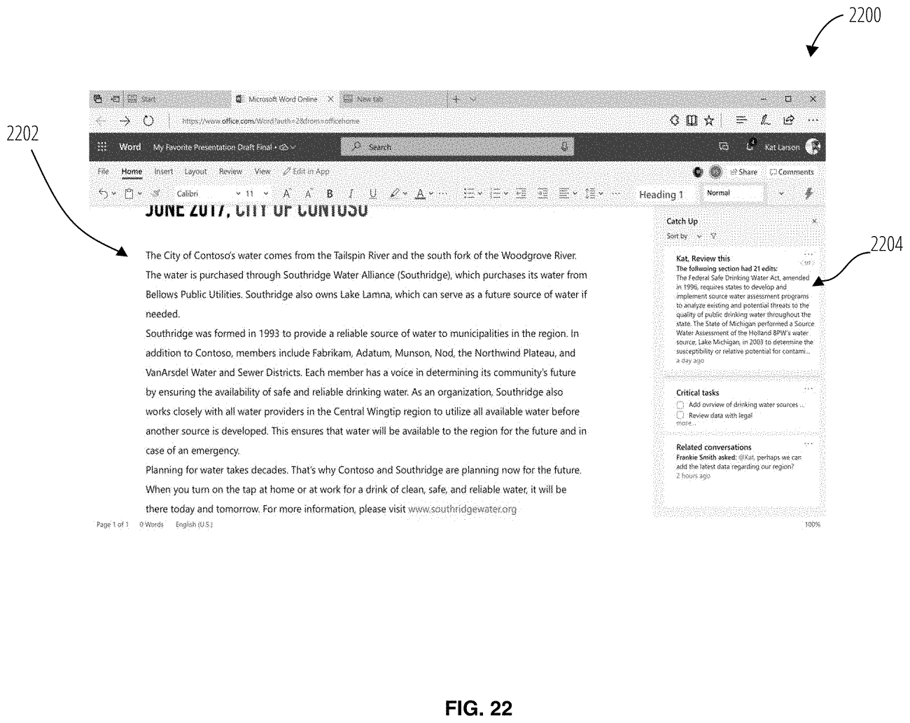

FIG. 22 illustrates a screenshot 2200 in accordance with one embodiment. The screenshot 2200 illustrates a shared document 2202 with an annotated box 2204. A summary of changes (e.g., number of edits) to a section of the shared document 2002 is displayed in the annotated box 2204.

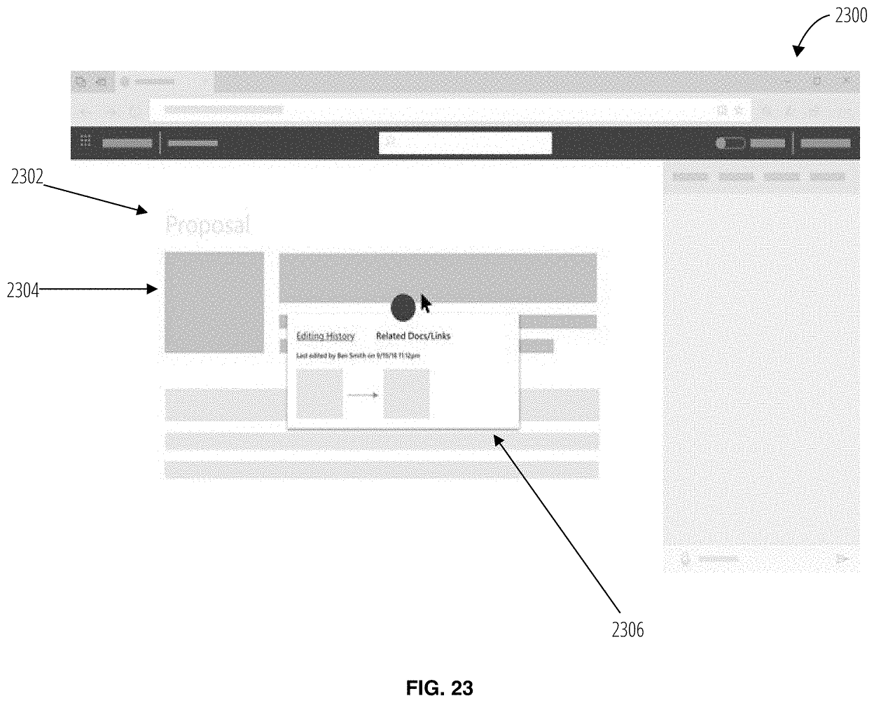

FIG. 23 illustrates a screenshot 2300 in accordance with one embodiment. The screenshot 2300 illustrates a shared document 2302. A user hovers their pointer over a selected portion 2304 of the shared document 2302. In response, the granular history 2306 is displayed for the selected portion 2304.

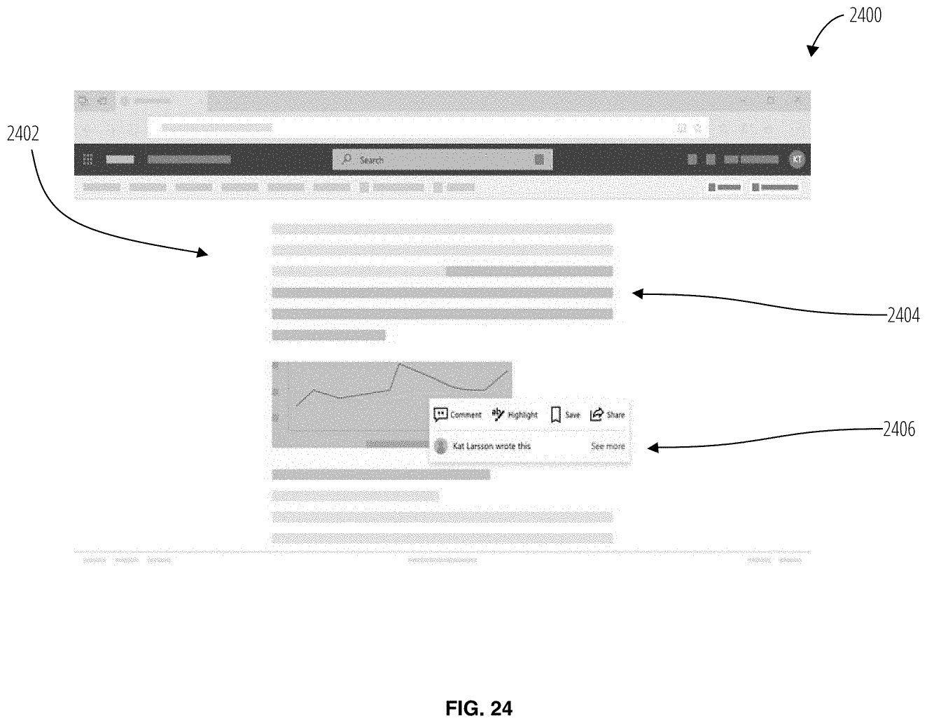

FIG. 24 illustrates a screenshot 2400 in accordance with one embodiment. The screenshot 2400 illustrates a shared document 2402 with selected portion 2404. The granular changes 2406 are displayed for the selected portion 2404.

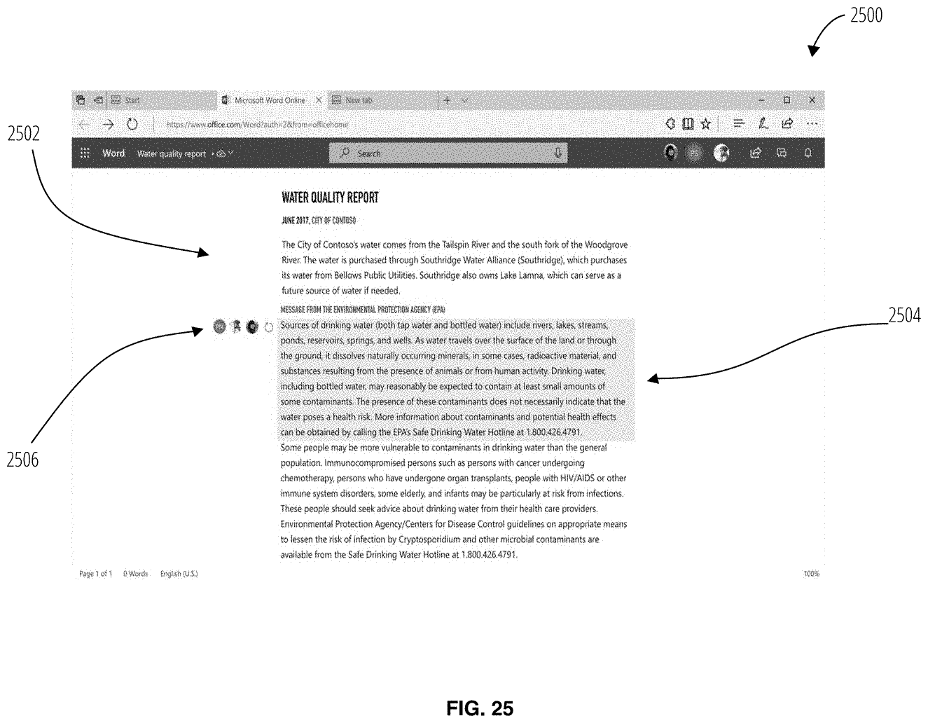

FIG. 25 illustrates a screenshot 2500 in accordance with one embodiment. The screenshot 2500 illustrates a shared document 2502 with selected portion 2504. Icons or avatars representing every user who edited the selected portion 2504 is displayed next to the selected portion 2504.

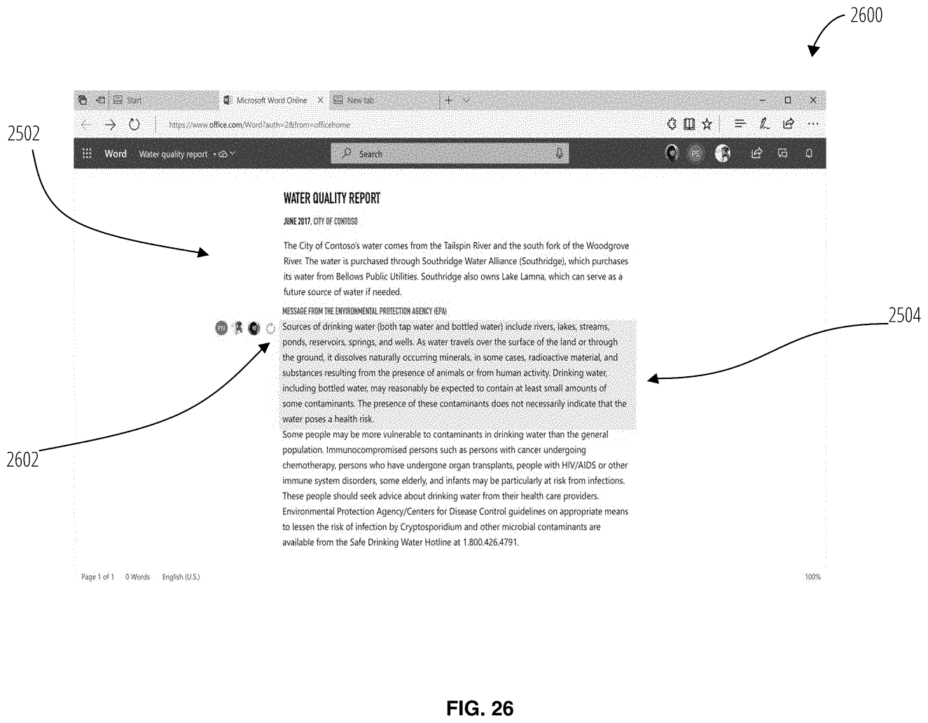

FIG. 26 illustrates a screenshot 2600 in accordance with one embodiment. The screenshot 2600 illustrates a shared document 2502 with selected portion 2504. The user selects or clicks on a history icon 2602 (that is displayed next to the selected portion 2504) to view chronological (or non-linear) changes or edits to the selected portion 2504.

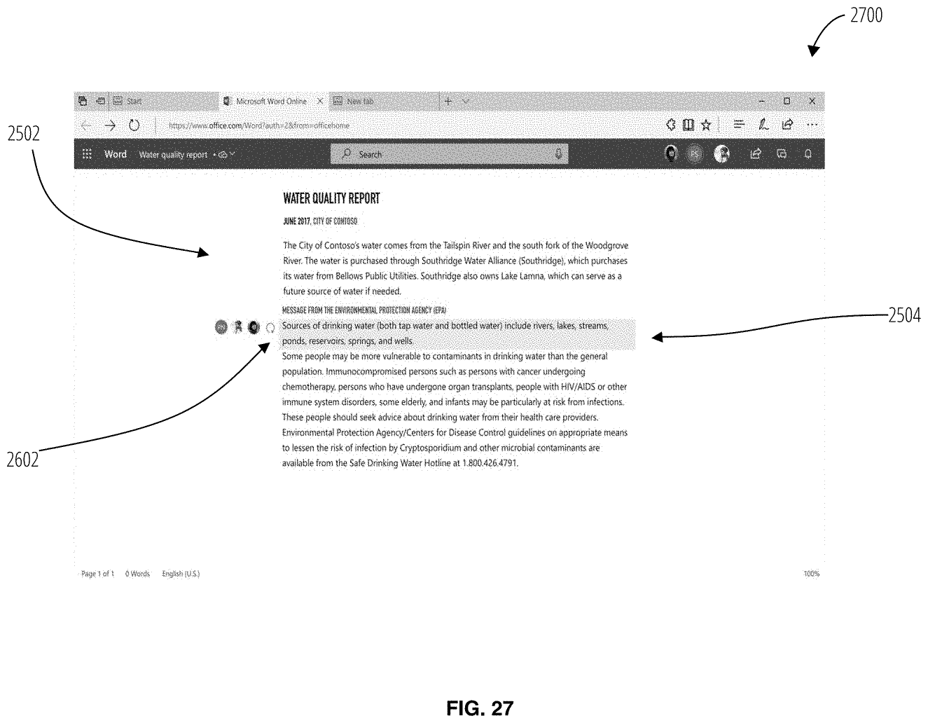

FIG. 27 illustrates a screenshot 2700 in accordance with one embodiment. The screenshot 2700 illustrates a shared document 2502 with selected portion 2504. The user selects or clicks again the history icon 2602 to display further prior changes or edits to the selected portion 2504 (performed by all shared users or a selected or identified user). For example, the shared document 2502 displays changes performed by one specific user over time with respect to the selected portion 2504. In another example, the shared document 2502 displays changes performed by all users (having edit access to the shared document 2502) with respect to the selected portion 2504.

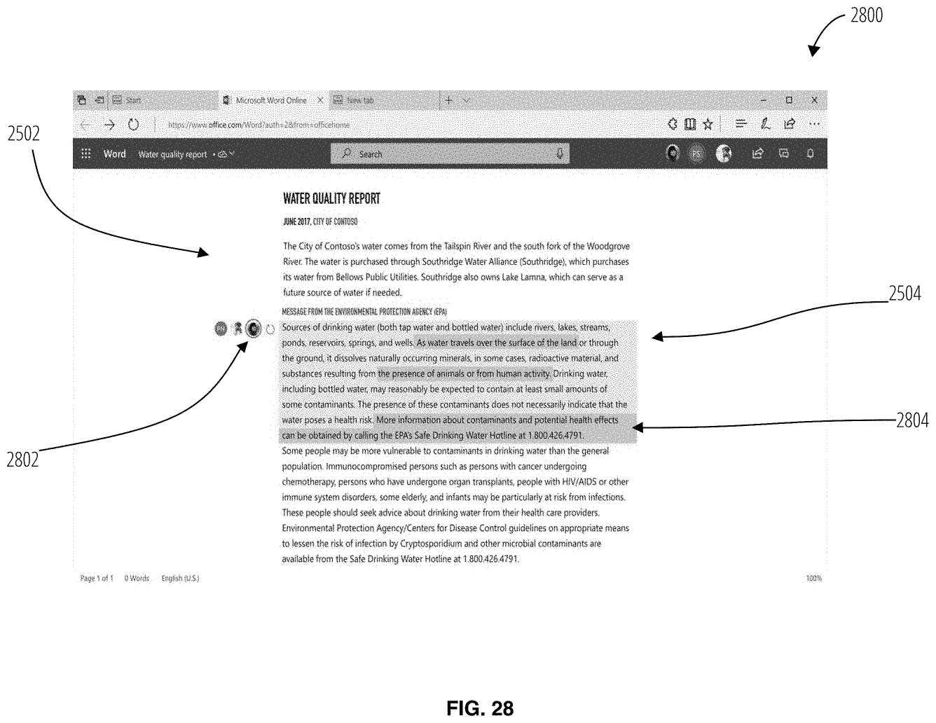

FIG. 28 illustrates a screenshot 2800 in accordance with one embodiment. The screenshot 2800 illustrates the shared document 2502 with selected portion 2504. A user selects or click on a user icon 2802 (displayed next to the selected portion 2504). Edits 2804 performed by a user corresponding to the user icon 2802 are visually indicated (e.g., highlighted) for the selected portion 2504.

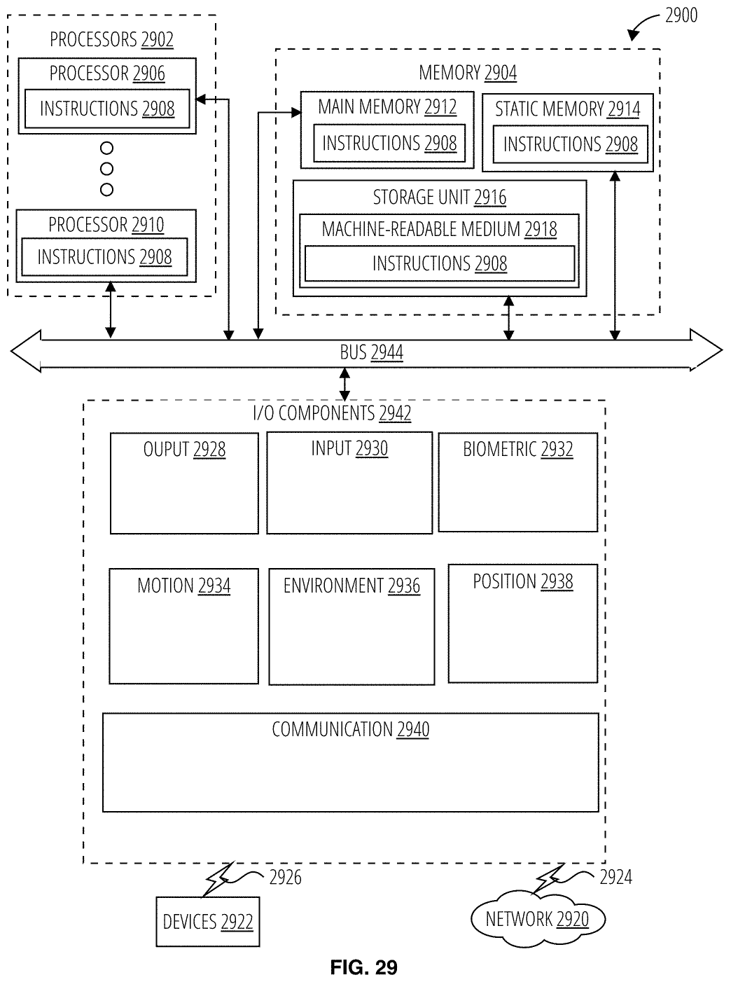

FIG. 29 is a diagrammatic representation of the machine 2900 within which instructions 2908 (e.g., software, a program, an application, an applet, an app, or other executable code) for causing the machine 2900 to perform any one or more of the methodologies discussed herein may be executed. For example, the instructions 2908 may cause the machine 2900 to execute any one or more of the methods described herein. The instructions 2908 transform the general, non-programmed machine 2900 into a particular machine 2900 programmed to carry out the described and illustrated functions in the manner described. The machine 2900 may operate as a standalone device or may be coupled (e.g., networked) to other machines. In a networked deployment, the machine 2900 may operate in the capacity of a server machine or a client machine in a server-client network environment, or as a peer machine in a peer-to-peer (or distributed) network environment. The machine 2900 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2908, sequentially or otherwise, that specify actions to be taken by the machine 2900. Further, while only a single machine 2900 is illustrated, the term “machine” shall also be taken to include a collection of machines that individually or jointly execute the instructions 2908 to perform any one or more of the methodologies discussed herein.

The machine 2900 may include processors 2902, memory 2904, and I/O components 2942, which may be configured to communicate with each other via a bus 2944. In an example embodiment, the processors 2902 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 2906 and a processor 2910 that execute the instructions 2908. The term “processor” is intended to include multi-core processors that may comprise two or more independent processors (sometimes referred to as “cores”) that may execute instructions contemporaneously. Although FIG. 29 shows multiple processors 2902, the machine 2900 may include a single processor with a single core, a single processor with multiple cores (e.g., a multi-core processor), multiple processors with a single core, multiple processors with multiples cores, or any combination thereof.

The memory 2904 includes a main memory 2912, a static memory 2914, and a storage unit 2916, both accessible to the processors 2902 via the bus 2944. The main memory 2904, the static memory 2914, and storage unit 2916 store the instructions 2908 embodying any one or more of the methodologies or functions described herein. The instructions 2908 may also reside, completely or partially, within the main memory 2912, within the static memory 2914, within machine-readable medium 2918 within the storage unit 2916, within at least one of the processors 2902 (e.g., within the processor's cache memory), or any suitable combination thereof, during execution thereof by the machine 2900.

The I/O components 2942 may include a wide variety of components to receive input, provide output, produce output, transmit information, exchange information, capture measurements, and so on. The specific I/O components 2942 that are included in a particular machine will depend on the type of machine. For example, portable machines such as mobile phones may include a touch input device or other such input mechanisms, while a headless server machine will likely not include such a touch input device. It will be appreciated that the I/O components 2942 may include many other components that are not shown in FIG. 29. In various example embodiments, the I/O components 2942 may include output components 2928 and input components 2930. The output components 2928 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2930 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 2942 may include biometric components 2932, motion components 2934, environmental components 2936, or position components 2938, among a wide array of other components. For example, the biometric components 2932 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 2934 include acceleration sensor components (e.g., accelerometer), gravitation sensor components, rotation sensor components (e.g., gyroscope), and so forth. The environmental components 2936 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2938 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2942 further include communication components 2940 operable to couple the machine 2900 to a network 2920 or devices 2922 via a coupling 2924 and a coupling 2926, respectively. For example, the communication components 2940 may include a network interface component or another suitable device to interface with the network 2920. In further examples, the communication components 2940 may include wired communication components, wireless communication components, cellular communication components. Near Field Communication (NFC) components, Bluetooth® components (e.g., Bluetooth® Low Energy), Wi-Fi® components, and other communication components to provide communication via other modalities. The devices 2922 may be another machine or any of a wide variety of peripheral devices (e.g., a peripheral device coupled via a USB).

Moreover, the communication components 2940 may detect identifiers or include components operable to detect identifiers. For example, the communication components 2940 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2940, such as location via Internet Protocol (IP) geolocation, location via Wi-Fi® signal triangulation, location via detecting an NFC beacon signal that may indicate a particular location, and so forth.

The various memories (e.g., memory 2904, main memory 2912, static memory 2914, and/or memory of the processors 2902) and/or storage unit 2916 may store one or more sets of instructions and data structures (e.g., software) embodying or used by any one or more of the methodologies or functions described herein. These instructions (e.g., the instructions 2908), when executed by processors 2902, cause various operations to implement the disclosed embodiments.

The instructions 2908 may be transmitted or received over the network 2920, using a transmission medium, via a network interface device (e.g., a network interface component included in the communication components 2940) and using any one of a number of well-known transfer protocols (e.g., hypertext transfer protocol (HTTP)). Similarly, the instructions 2908 may be transmitted or received using a transmission medium via the coupling 2926 (e.g., a peer-to-peer coupling) to the devices 2922.

### Examples

Example 1 is a computer-implemented method comprising: detecting changes to a shared document from a plurality of users; determining change activities and corresponding provenance to the shared document in response to detecting the changes; and generating a context of granular changes based on the change activities and corresponding provenance to the shared document; and generating a graphical user interface based on the context, the graphical user interface providing a visualization of the granular changes.

In example 2, the subject matter of example 1 further comprises: receiving a semantic query related to change activities to the shared document; identifying granular changes to the shared document based on the semantic query, the change activities and the corresponding provenance; modifying the graphical user interface based on the identified granular changes; and causing a display of the modified graphical user interface at a client device.

In example 3, the subject matter of example 1 further comprises: determining a quality of change for each user based on the change activities and the corresponding provenance to the shared document, wherein the graphical user interface provides a visualization of the quality of change for one or more users of the plurality of users.

In example 4, the subject matter of example 1 further comprises: wherein generating the graphical user interface further comprises: visually identifying a portion of the shared document according to granular changes corresponding to the portion of the shared document.

In example 5, the subject matter of example 1 further comprises: receiving an identification of a portion of the shared document; identifying granular changes in the identified portion of the shared document; and causing a display of the granular changes only for the identified portion of the shared document in the graphical user interface.

In example 6, the subject matter of example 1 further comprises: receiving an identification of a portion of the shared document via the graphical user interface; identifying granular changes corresponding to the identified portion of the shared document; and generating a visualization of the granular changes for the portion of the shared document in the graphical user interface.

In example 7, the subject matter of example 1 further comprises: wherein generating the context further comprises: aggregating changes based on types of changes for one or more users from the plurality of users; and providing a visualization of the aggregated changes in the graphical user interface.

In example 8, the subject matter of example 1 further comprises: determining a modification view privacy setting of one or more users of the plurality of users; determining that an attribute corresponding to a portion of the granular changes corresponds to the modification view privacy setting of the one or more users; and omitting, from the visualization of the granular changes, the portion of the granular changes corresponding to the modification view privacy setting of the one or more users.

In example 9, the subject matter of example 1 further comprises: determining a shared document privacy setting of one or more users of the plurality of users; aggregating changes to the shared document based on the shared document privacy setting of one or more users; and providing a visualization of the aggregated changes in the graphical user interface.

In example 10, the subject matter of example 1 further comprises: wherein the graphical user interface provides a high level view of the change activities, wherein the graphical user interface replaces the high level view of the change activities with a low level view of the changes activities in response to a user input, the high level view providing a summary of the change activities, the low level view providing a detailed history of the change activities.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

1. A computer-implemented method comprising:
detecting changes to a shared document from a plurality of users;
determining change activities and corresponding provenance to the shared document in response to detecting the changes;
generating a context of granular changes based on the change activities and corresponding provenance to the shared document, and a privilege document setting of the shared document; and
generating a graphical user interface based on the context, the graphical user interface providing a visualization of the granular changes, the granular changes indicating a quality of the change activities by a corresponding provenance, a broad summary of change activities by a corresponding provenance for users associated with a first privilege right with respect to the privilege document setting, and a detailed summary of change activities by a corresponding provenance for users associated with a second privilege right with respect to the privilege document setting.

2. The computer-implemented method of claim 1, further comprising:
receiving a semantic query related to change activities to the shared document;
identifying granular changes to the shared document based on the semantic query, the change activities and the corresponding provenance;
modifying the graphical user interface based on the identified granular changes; and
causing a display of the modified graphical user interface at a client device.

3. The computer-implemented method of claim 1, further comprising:
determining a quality of change for each user based on the change activities and the corresponding provenance to the shared document,
wherein the graphical user interface provides a visualization of the quality of change for one or more users of the plurality of users.

4. The computer-implemented method of claim 1, wherein generating the graphical user interface further comprises:
visually identifying a portion of the shared document according to granular changes corresponding to the portion of the shared document.

5. The computer-implemented method of claim 1, further comprising:
receiving an identification of a portion of the shared document;
identifying granular changes in the identified portion of the shared document; and
causing a display of the granular changes only for the identified portion of the shared document in the graphical user interface.

6. The computer-implemented method of claim 1, further comprising:
receiving an identification of a portion of the shared document via the graphical user interface;
identifying granular changes corresponding to the identified portion of the shared document; and
generating a visualization of the granular changes for the portion of the shared document in the graphical user interface.

7. The computer-implemented method of claim 1, wherein generating the context further comprises:
aggregating changes based on types of changes for one or more users from the plurality of users; and
providing a visualization of the aggregated changes in the graphical user interface.

8. The computer-implemented method of claim 1, further comprising:
determining a modification view privacy setting of one or more users of the plurality of users;
determining that an attribute corresponding to a portion of the granular changes corresponds to the modification view privacy setting of the one or more users; and
omitting, from the visualization of the granular changes, the portion of the granular changes corresponding to the modification view privacy setting of the one or more users.

9. The computer-implemented method of claim 1, further comprising:
determining a shared document privacy setting of one or more users of the plurality of users;
aggregating changes to the shared document based on the shared document privacy setting of one or more users; and
providing a visualization of the aggregated changes in the graphical user interface.

10. The computer-implemented method of claim 1, wherein the graphical user interface provides a high level view of the change activities,
wherein the graphical user interface replaces the high level view of the change activities with a low level view of the changes activities in response to a user input, the high level view providing a summary of the change activities, the low level view providing a detailed history of the change activities.

11. A computing apparatus, the computing apparatus comprising:
a processor; and
a memory storing instructions that, when executed by the processor, configure the apparatus to:
detect changes to a shared document from a plurality of users;
determine change activities and corresponding provenance to the shared document in response to detecting the changes;
generate a context of granular changes based on the change activities and corresponding provenance to the shared document, and a privilege document setting of the shared document; and
generate a graphical user interface based on the context, the graphical user interface providing a visualization of the granular changes, the granular changes indicating a quality of the change activities by a corresponding provenance, a broad summary of change activities by a corresponding provenance for users associated with a first privilege right with respect to the privilege document setting, and a detailed summary of change activities by a corresponding provenance for users associated with a second privilege right with respect to the privilege document setting.

12. The computing apparatus of claim 11, wherein the instructions further configure the apparatus to:
receive a semantic query related to change activities to the shared document;
identify granular changes to the shared document based on the semantic query, the change activities and the corresponding provenance;
modify the graphical user interface based on the identified granular changes; and
cause a display of the modified graphical user interface at a client device.

13. The computing apparatus of claim 11, wherein the instructions further configure the apparatus to:
determine a quality of change for each user based on the change activities and the corresponding provenance to the shared document,
wherein the graphical user interface provides a visualization of the quality of change for one or more users of the plurality of users.

14. The computing apparatus of claim 11, wherein generating the graphical user interface further comprises:
visually identify a portion of the shared document according to granular changes corresponding to the portion of the shared document.

15. The computing apparatus of claim 11, wherein the instructions further configure the apparatus to:
receive an identification of a portion of the shared document;
identify granular changes in the identified portion of the shared document; and
cause a display of the granular changes only for the identified portion of the shared document in the graphical user interface.

16. The computing apparatus of claim 11, wherein the instructions further configure the apparatus to:
receive an identification of a portion of the shared document via the graphical user interface;
identify granular changes corresponding to the identified portion of the shared document; and
generate a visualization of the granular changes for the portion of the shared document in the graphical user interface.

17. The computing apparatus of claim 11, wherein generating the context further comprises:
aggregate changes based on types of changes for one or more users from the plurality of users; and
provide a visualization of the aggregated changes in the graphical user interface.

18. The computing apparatus of claim 11, wherein the instructions further configure the apparatus to:
determine a modification view privacy setting of one or more users of the plurality of users;
determine that an attribute corresponding to a portion of the granular changes corresponds to the modification view privacy setting of the one or more users; and
omit, from the visualization of the granular changes, the portion of the granular changes corresponding to the modification view privacy setting of the one or more users.

19. The computing apparatus of claim 11, wherein the instructions further configure the apparatus to:
determine a shared document privacy setting of one or more users of the plurality of users;
aggregate changes to the shared document based on the shared document privacy setting of one or more users; and
provide a visualization of the aggregated changes in the graphical user interface.

20. A non-transitory computer-readable storage medium, the computer-readable storage medium including instructions that when executed by a computer, cause the computer to perform operations comprising:
detect changes to a shared document from a plurality of users;
determine change activities and corresponding provenance to the shared document in response to detecting the changes; and
generate a context of granular changes based on the change activities and corresponding provenance to the shared document, and a privilege document setting of the shared document; and
generate a graphical user interface based on the context, the graphical user interface providing a visualization of the granular changes, the granular changes indicating a quality of the change activities by a corresponding provenance, a broad summary of change activities by a corresponding provenance for users associated with a first privilege right with respect to the privilege document setting, and a detailed summary of change activities by a corresponding provenance for users associated with a second privilege right with respect to the privilege document setting.
